(19) United States
(12) Patent Application Publication
(10) Pub. No.: US 2024/0191737 A1
(43) Pub. Date: Jun. 13, 2024

(54) FLUID FURNITURE

(71) Applicant: Franklin Preston DUCK, Las Vegas, NV (US)

(72) Inventor: Franklin Preston DUCK, Las Vegas, NV (US)

(21) Appl. No.: 18/076,416

(22) Filed: Dec. 7, 2022

(51) Int. Cl. F16B 12/14; A47B 47/02; A47B 47/04

(52) U.S. Cl. CPC F16B 12/14; A47B 47/02; A47B 47/042

(57) ABSTRACT

Furniture includes at least one part or piece. The at least one part contains at least one fastening device. The at least one fastening device enables the at least one part to be removed from the furniture. If multiple parts are removed from a piece of furniture, the furniture can be changed into a different form of furniture and also change into a different function and use. When at least two different furniture are disassembled, the parts removed from the different furniture can be combined or interchanged with the at least two different furniture to form a new piece of furniture that has the same or different size and has the same or different use.

### TECHNICAL FIELD

The present disclosure relates to furniture, specifically furniture that is fluid. More specifically, the present disclosure relates to furniture which is easily disassembled, interchangeable, and combinable with similar disassembled, interchangeable, and combinable furniture and/or furniture.

### BACKGROUND

Existing furniture has many problems such as typically being very heavy, cumbersome, awkwardly sized, and having a fixed size, all of which make moving the existing furniture difficult. Also, existing furniture is comprised of pieces or parts that are fixedly secured together and thus making the furniture hard to move and having only one functional use. For example, in the workplace, a worker uses an office cubical/desk but if or when the business closes down or downsizes or moves, this office cubical/desk cannot be transformed into a different structure or a different desired use such as a bed, a dresser or another piece of desired furniture other than an office cubical/desk. Due to the existing furniture having only one use, a user must purchase additional furniture to obtain another desired function or use. Therefore, the value of each furniture investment is large, and this large investment is lost over time due to the furniture being lost, damaged, broken, or no long demanded due to use and/or style.

Moving heavy furniture and large pieces of furniture comes with a large expense, increases the required time to move such furniture, increases the probability this furniture will become damaged as well as creates hazards with moving this heavy and awkwardly large and/or heavy furniture.

Thus, there is a present need for furniture which can be easily and inexpensively moved, has multiple uses, and can be easily disassembled, interchanged, and combined.

The present disclosure has solved the above problems of furniture being very heavy, cumbersome, awkwardly sized, having a fixed size, being hard to move, and having only one functional use with the detailed below disclose of furniture being easily disassembled, interchanged, and combined. The disclosed furniture is easily disassembled, interchangeable, and combinable and has many advantages over existing furniture such as saving money; obtaining a different function and/or use of the furniture; being easier and cheaper to move and less damage when moving the furniture because, for example, when an existing piece of furniture such as a file cabinet is no longer needed, one will not lose money on the no longer needed file cabinet because the present inventions' file cabinet can be easily disassembled and then transformed into for example a large conference room table within an office setting, which is needed and required.

Additionally, Applicants' disclosure and invention has problem solved many other problems such as reducing humanity's carbon footprint since Applicant's disclosed furniture will not become burned, broken, discarded as waste or trash, or discarded on the side of the road as waste or trash such as current known fixed old and unused furniture because Applicant's disclosed furniture is easily disassembled, interchangeable with other pieces or parts of Applicant's disclosed interchangeable furniture, pieces and/or parts and/or can be combined with other interchangeable furniture or disassembled pieces and/or parts of Applicant's disclosed interchangeable furniture. Moreover, the materials used to make Applicant's disclosed furniture are recyclable and reusable whereas current fixed furniture and parts are not interchangeably combinable and thus are not reusable and are rarely recycled. Therefore, Applicant's disclosed furniture is reusable, and with ever-changing design, Applicant's disclosed interchangeable furniture eliminates the many above-stated issues and problems related to humanity's carbon footprint.

Moreover, due to current fixed furniture, there are many storage units filled with furniture and/or items collecting dust such as desks, shelves, cabinets, file cabinets, cubicles, tables, and countless other items sitting in garages or costly storage units that have no current use to owners. All of this furniture and items would still be useful if they were interchangeable furniture of Applicant's disclosure. Additionally, pages upon pages of classified advertisements are filled with non-reusable fixed furniture and items as owners try to recover a portion of their investment. Contrarily, Applicant's interchangeable furniture can change if or when the need for the furniture or design of the furniture changes. Thus, humanity's harm to the environment will be lowered since less trash and excess will be created. Furthermore, people can depend on their investment in Applicant's interchangeable furniture because the interchangeable furniture will continue to be useful for months and years far into the future.

### SUMMARY

The present disclosure relates to furniture which is easily disassembled, interchangeable, and combinable with similar disassembled, interchangeable and combinable furniture and/or furniture. Therefore, the furniture can be easily disassembled (i.e. broken down) and/or transformed into a different structure and/or piece of furniture which has the same and/or different function or use. This allows the furniture to change as the use of the furniture changes; the furniture is fluid. Thus, the furniture does not lose its value. Moreover, when the furniture needs to be moved, a person can be easily disassembled the furniture and easily transport the furniture in a smaller transport vehicle such as a truck, Sport Utility Vehicle (SUV), or even an automobile, which makes the furniture much easier and less expensive to move and transport as well as providing a less chance of scratching and/or damaging the furniture. For example, a large office cubical/desk can be disassembled into small pieces, placed in one's vehicle, and transported to a location, such as a home, and made into a workbench for one to make different items, where the different items are created based on one's hobby. Therefore, office furniture can be transformed into furniture which has a new function and a new use. The above example is only one such example, but many other furniture examples are included in this disclosure. A few more examples, but other examples can be deduced, are a kitchen cabinet can be transformed into a desk; a desk can be transformed into a workbench; a workbench can be transformed into an entertainment center; an entertainment center can be transformed into shelving; shelving can be transformed into a table; a file cabinet can be transformed into a conference room table, a cubical, a large or small desk and/or wall shelves. Therefore, the disclosed furniture can be used in all facets of a person's life and for the entire life of a person and even a longer period of time such as hundreds of years. Also, out-of-date office furniture and be turned into modern-day use office furniture. For example, a person grows, matures and ages, and the furniture can be easily disassembled, interchanged, and/or combined with similar disassembled, interchangeable and combinable furniture and/or furniture to expand and/or shrink in length, height, and/or width of the furniture as the needs of the person which grows, matures and ages. Thus, a single person, instead of multiple people, can move from a kitchen, a kitchen table, and one or more kitchen cabinets, by disassembling the kitchen table and cabinet(s) and interchange the kitchen table and one or more kitchen cabinets and/or combine the kitchen table and one or more kitchen cabinets to form an office desk in another room in a house such as a home office.

Applicant's invention and disclosure of interchangeable furniture can easily upgrade and undergo expansions. For example, extra pieces can be bought separately or incorporated from other items, pieces, parts, or furniture. If one's business expands, with Applicant's interchangeable furniture one can turn a simple computer desk into for example an L shape desk or an executive type of desk. If one obtains a larger or bigger television, with Applicant's interchangeable furniture one can build a larger entertainment center. If one needs more space for an ever-growing tool collection, with Applicant's interchangeable furniture one can build a bigger workbench. If one needs more shelf space for one's growing book collection, with Applicant's interchangeable furniture one can just add more pieces.

If a person or couple has a couple of children, with Applicant's interchangeable furniture, the person or couple can expand and/or upgrade the kitchen space, the toy storage, dressers, and many more spaces and items. Any of Applicant's interchangeable furniture, parts, or pieces can be upgraded and/or can be scaled up or scaled down in size when needed.

Additionally, Applicant's interchangeable furniture can be used for kitchen cabinetry. Using Applicant's interchangeable furniture for kitchens and/or cabinetry, one can obtain a kitchen that can be changed, upgraded, downsized, and moved. Many people spend their whole life with the same kitchen configuration. Upgrades are costly. With Applicant's interchangeable furniture, as needs, situations, and family sizes change, so can one's kitchen. Having been in your house for example ten or more years and want a change, or change some feature within the house, with Applicant's interchangeable furniture moving, changing, or upgrading your cabinet space is performed with ease. People will now be able to change the size, style, and orientation of their kitchens with the use of Applicant's interchangeable furniture. Using Applicant's interchangeable furniture, one can easily customize kitchens, other rooms, spaces, and furniture as one sees fit or for one's needs and the needs of a family. Also, using Applicant's interchangeable furniture, one can easily assemble outdoor kitchens, poolside bars, and grills as well as other rooms, spaces, and furniture.

Additionally, Applicant's interchangeable furniture does have many uses and/or changes in use. As well as the longevity and return on investment of Applicant's interchangeable furniture, a person can use Applicant's interchangeable furniture in all aspects of life. A person can also use Applicant's interchangeable furniture for life (i.e. their living space as well as for generations to come). For example, using Applicant's interchangeable furniture one's childhood bunk bed can become one's desk and/or workstation in high school, office, or equivalent place. Using Applicant's interchangeable furniture, one's high school desk and/or workstation becomes one's entertainment center in college. Thus, with only one investment in Applicant's interchangeable furniture, one obtains a range of multiple uses.

The range and deployment of Applicant's interchangeable furniture are disclosed below. Applicant's interchangeable furniture is easily stored, broken down (i.e. disassembled), and easily moved. Since Applicant's interchangeable furniture has many indoor and outdoor applications and has ever-changing functionality, Applicant's interchangeable furniture will be a must-have in many households, offices, and businesses. Applicant's interchangeable furniture can be useful just about anywhere. Areas of use include, but are not limited to education, medical, military, industrial/industry, commercial, residential, business, retail, food and dining, childcare, assisted living, hotels and resorts, event and convention centers, entertainment venues and stadiums, bars and clubs, and apartment complexes. By using Applicant's interchangeable furniture, if someone or a business owner imagines being in a hotel and can change the attitude and presentation of the room(s) every few years without having to purchase new furniture, there will be cost savings and thus create demand and use for Applicant's interchangeable furniture. Similarly, imagine being in a bar, club, or restaurant that could easily change its configuration for special events and shows. Every year using Applicant's interchangeable furniture you have already purchased you could change the look of your business, office, classroom, retail space, and other equivalent spaces and rooms at your leisure in a fast, simple, easy manner and at no capital expenditure.

The furniture material is made from a variety of materials and a specific material is used depending upon the required or desired use. The furniture material is made from an alloy, composites, plastic, plexiglass, glass, cardboard, wood, embedded fiber material, steel, aluminum, or any type of metal. The furniture can be made from a combination of one or more of the above materials.

The furniture includes interchanging interlocking parts on some or all pieces/parts which comprise the furniture. These interchanging interlocking parts are recessed in or attached or installed on some or all pieces/parts of the furniture. Moreover, these interchanging interlocking parts are attached or secured to an inner surface of some or all pieces of the furniture by using a glue, a sealant, an epoxy, a groove and O-ring seal, a friction fit seal, or equivalent attachment apparatus or by welding, soldering, riveting, securing screws through holes formed in the pieces/parts or ports of the furniture.

### BRIEF DESCRIPTION OF THE DRAWINGS

To more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without an inventive effort.

FIG. 1 is an illustration of furniture having apertures, fastening devices, and other structures or furniture parts/pieces added thereto.

FIG. 2 is an illustration of a structure or furniture part/piece having a fastening mechanism.

FIG. 3 is an illustration of one end of a structure or furniture part/piece having a fastening apparatus.

FIG. 4 is an illustration of the furniture of the present disclosure.

### DETAILED DESCRIPTION

The technical solutions of the present disclosure will be clearly and completely described below with reference to the drawings. The embodiments described are only some of the embodiments of the present disclosure, rather than all of the embodiments. All other embodiments that are obtained by a person of ordinary skill in the art on the basis of the embodiments of the present disclosure without an inventive effort shall be covered by the protective scope of the present disclosure.

In the description of the present disclosure, it is to be noted that the orientational or positional relation denoted by the terms such as “center”, “upper”, “lower”, “left”, “right”, “vertical”, “horizontal”, “inner” and “outer” is based on the orientation or position relationship indicated by the figures, which only serves to facilitate describing the present disclosure and simplify the description, rather than indicating or suggesting that the device or element referred to must have a particular orientation, or is constructed or operated in a particular orientation, and therefore cannot be construed as a limitation on the present disclosure. In addition, the terms “first”, “second” and “third” merely serve the purpose of description and should not be understood as an indication or implication of relative importance.

In the description of the present disclosure, it should be noted that unless otherwise explicitly specified and defined, the terms “install”, “link”, “attach” and “connect” shall be understood in the broadest sense, which may, for example, refer to fixed connection, detachable connection or integral connection; may refer to mechanical connection or electrical connection; may refer to direct connection or indirect connection by means of an intermediate medium; and may refer to communication between two elements. A person of ordinary skill in the art would understand the specific meaning of the terms in the present disclosure according to the specific situations.

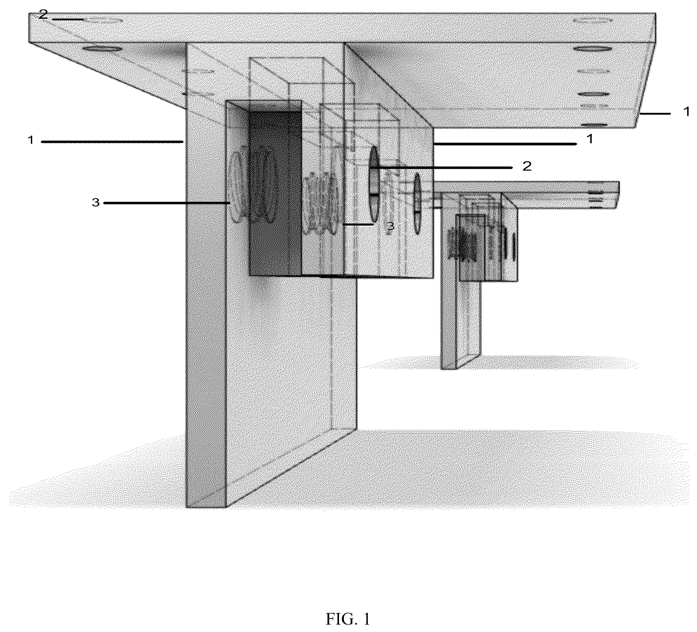

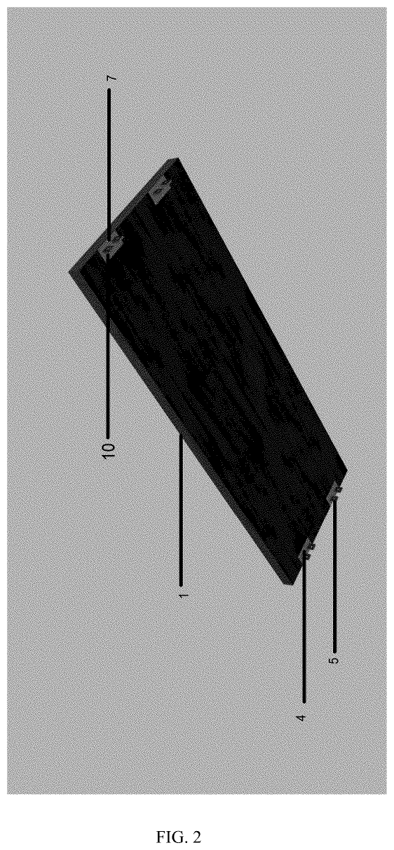

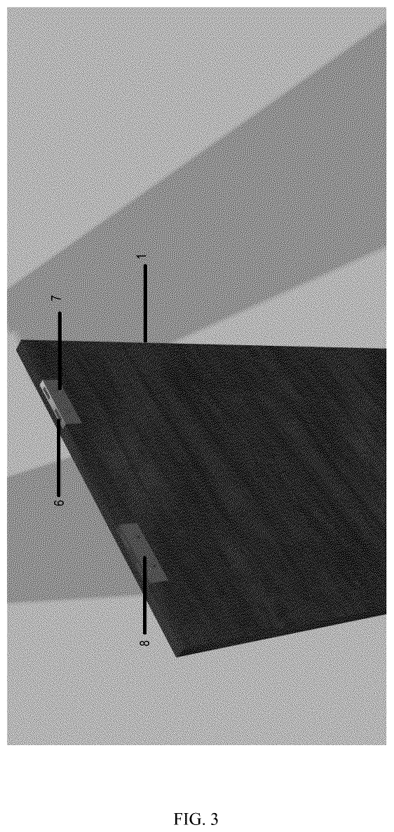

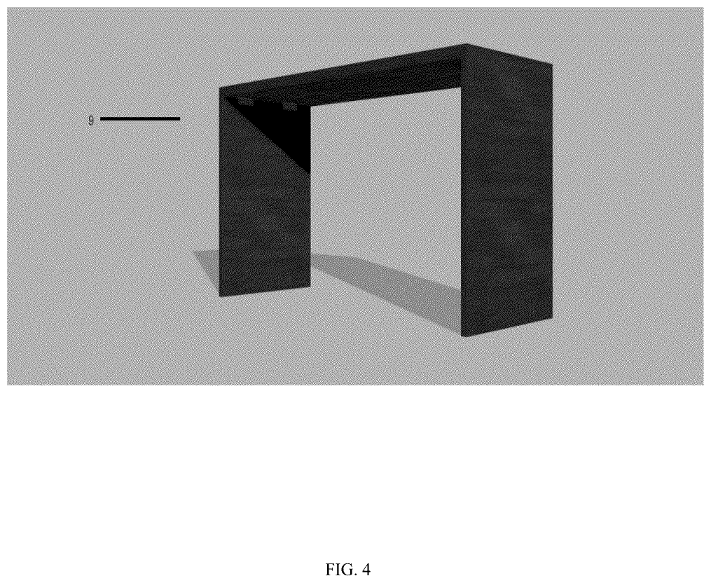

FIG. 1, FIG. 2, FIG. 3 and FIG. 4 illustrate the disclosed invention, where the figures are not drawn to scale. Also, the locations and positions of the devices within the drawings are only for illustrative purposes and these devices can be located at any location and position within the drawing illustrations.

As shown in FIG. 1 and FIG. 4, the present disclosure relates to furniture 9 which is easily disassembled, interchangeable, and combinable, with similar disassembled, interchangeable and combinable furniture 9 and/or furniture. Therefore, the furniture 9 can be easily disassembled (i.e. broken down) and/or transformed into a different structure and/or piece of furniture 9 which has the same and/or different function or use. This allows the furniture 9 to change as the use of the furniture 9 changes. Thus, the furniture 9 does not lose its value. Moreover, when the furniture 9 needs to be moved, a person can easily disassemble the furniture 9 and easily transport the furniture 9 in a smaller transport vehicle such as a truck, Sport Utility Vehicle (SUV), or even an automobile, which makes the furniture 9 much easier and less expensive to move and transport as well as providing a less chance of scratching and/or damaging the furniture 9. For example, a large office cubical/desk can be disassembled into small pieces, placed in one's vehicle and transported to a location such as a home and made into a workbench for one to make different items, where the different items are created based on one's hobby. Therefore, office furniture can be transformed into furniture 9 which has a new function and a new use. The above example is only one such example, but many other furniture examples are included in this disclosure. A few more examples, but other examples can be deduced, are a kitchen cabinet can be transformed into a desk; a desk can be transformed into a workbench; a workbench can be transformed into an entertainment center; an entertainment center can be transformed into shelving; shelving can be transformed into a table; a file cabinet can be transformed into a conference room table, a cubical, a large or small desk and/or wall shelves. Therefore, the disclosed furniture 9 can be used in all facets of a person's life and for the entire life of a person and even a longer period of time such as hundreds of years. Also, out-of-date office furniture and be turned into modern-day use office furniture. For example, a person grows, matures and ages and the furniture 9 can be easily disassembled, interchanged, and/or combined with similar disassembled, interchangeable, and combinable furniture 9 and/or furniture to expand and/or shrink in length, height and/or width of the furniture 9 as the needs of the person which grows, matures and ages. Thus, a single person, instead of multiple people, can move, from a kitchen, a kitchen table, and one or more kitchen cabinets by disassembling the kitchen table and cabinet(s) and interchange the kitchen table and one or more kitchen cabinets and/or combine the kitchen table and one or more kitchen cabinets to form an office desk in another room in a house such as a home office.

The furniture material is made from a variety of materials and a specific material is used depending upon the required or desired use. The furniture material is made from an alloy, composites, plastic, plexiglass, glass, cardboard, wood, embedded fiber material, steel, aluminum, or any type of metal. The furniture can be made from a combination of one or more of the above materials.

As shown in FIG. 1 and FIG. 4, the furniture 9 is comprised of at least one piece 1. More preferably, the furniture 9 is comprised of a plurality of pieces 1. The plurality of pieces 1 is connected together in a removable manner so the furniture 9 can have one or more pieces 1 removed from the furniture 9 to transform the furniture 9 into a different shape or form and/or the same or different use.

Each piece 1 may comprise one or more apertures 2 and/or one or more fastening structures as shown in FIG. 1.

The one or more apertures 2 are circular, square, rectangular, triangular, of any polygonal or geometric shape, or any combination thereof. Moreover, the one or more apertures 2 can are arranged in rows, and/or columns, or staggered in a horizontal and/or vertical axis manner or a non-uniform or random manner or any combination thereof.

The one or more fastening structures can be a fastening device 3 as shown in FIG. 1 or a fastening mechanism which is comprised of a fastening plate(s) 4 and fastening protrusion(s) 5 as shown in FIG. 2, or a fastening apparatus which is comprised of a fastening piece(s) 8 and groove(s) 6 as shown in FIG. 3. The one or more fastening structures are made from an alloy, composites, plastic, wood, steel, aluminum or any type of metal or any combination of one or more of the above materials.

The fastening device 3 as shown in FIG. 1 and the fastening element(s) 7 as shown in FIG. 2 and FIG. 3 are a conventional screw that comprises a head and an elongated member attached to the head and provided with curved or angled threads, a rivet, a helical screw, or any combination thereof or any functionally equivalent removable device or apparatus. The fastening device 3 is used to attach any piece 1 which comprises/makes up the furniture 9 to another piece 1 of the furniture 9. The fastening device 3 is installed on any end or both ends and/or any and/or all side(s) and/or any location and position along the length, width, and/or height of each piece 1.

As shown in FIG. 2, the fastening plate 4 is attached to the piece 1 or embedded into the piece 1 in a depth direction of the piece 1. One or more fastening plates 4 are installed on any end or both ends and/or any and/or all side(s) and/or any location and position along the length, width, and/or height of each piece 1. The fastening plate 4 may be different in shape from one, some, or all other fastening plates 4 in one, some, or all pieces 1.

The fastening protrusions 5, as shown in FIG. 2, are connected/attached to the fastening plate 4 or connected in an integral manner (i.e. the fastening protrusions 5 and the fastening plate 4 are one (i.e. unitary) piece) with the fastening plate 4. The connection/attachment of the fastening protrusions 5 to the fastening plate 4 is by soldering, welding, gluing, or any equivalent attaching method. There may be one or a plurality of fastening protrusions 5 on each fastening plate 4. Holes 10 may be provided in all or some of the fastening protrusions 5. Each fastening protrusion 5 may be different in shape from one, some, or all other fastening protrusions 5 in one, some, or all pieces 1. Each fastening protrusion 5 is circular, square, rectangular, triangular, any polygonal or geometric shape, or any combination thereof.

As shown in FIG. 3, the fastening piece 8 is attached to the piece 1 or embedded into the piece 1 in a depth direction of the piece 1. One or more fastening pieces 8 are installed on any end or both ends and/or any and/or all side(s) and/or any location and position along the length, width, and/or height of each piece 1. The fastening piece 8 is circular, square, rectangular, triangular, or any polygonal or geometric shape. The fastening piece 8 may be different in shape from one, some, or all other fastening pieces 8 in one, some, or all pieces 1.

As shown in FIG. 3, grooves 6 are formed within one or a plurality of or all of the fastening pieces 8. There may be one or a plurality of grooves 6 formed within one, a plurality of, or all of the fastening pieces 8. The grooves 6 are circular, square, rectangular, triangular, or any polygonal or geometric shape. Each groove 6 may be different in shape from one, some, or all other grooves 6 in one, some, or all pieces 1.

The examples below show how the furniture 9 can be disassembled, interchangeable, and combinable with similar disassembled, interchangeable and combinable furniture 9. However, the below examples are only two such examples and there is a plurality of other ways of disassembling, interchanging, and combining with other furniture 9 which is covered by the disclosed invention.

For example, the furniture 9 as illustrated in FIG. 4 is formed with some pieces 1 comprising fastening plates 4 and fastening protrusions 5 as shown in FIG. 2, and other pieces 1 comprising fastening pieces 8 and grooves 6 as shown in FIG. 3. The fastening protrusions 5 are inserted within the grooves 6 of the fastening pieces 8.

Another example is furniture 9 as illustrated in FIG. 1 which shows a piece 1 from some other furniture 9, (e.g. a file cabinet) which is easily disassembled, interchangeable, and combinable, attached to a vertically positioned/oriented piece 1 by helical screws 3, where the vertically positioned/oriented piece 1 comprises fastening plates 4 and fastening protrusions 5, as shown in FIG. 2, and the horizontally positioned/oriented piece 1 illustrated in FIG. 1 comprising fastening pieces 8 and grooves 6 as shown in FIG. 3. The vertically positioned/oriented piece 1 and the horizontally positioned/oriented piece 1 illustrated in FIG. 1 are attached per the above previous example. Therefore, a piece 1 from a file cabinet is used to make a table which shows how a piece 1 of furniture 9 such as a file cabinet can be disassembled and be interchangeable and combinable with another piece of furniture 9 to make a table, where a table has a different size and a different use than a file cabinet.

What is claimed is:

1. Furniture comprising a plurality of pieces,
at least one first piece of the plurality of pieces comprises at least one fastening plate and at least one fastening protrusion,
at least one second piece of the plurality of pieces comprises at least one fastening piece and at least one groove, and
the at least one first piece and the at least one second piece are removably connected together.

2. The furniture according to claim 1, wherein the at least one fastening plate is attached to a first end of the least one first piece.

3. The furniture according to claim 2, wherein the at least one fastening plate comprises a plurality of plates and the plurality of plates are attached to the first end and a second end of the least one first piece.

4. The furniture according to claim 1, wherein the at least one fastening protrusion is connected to the at least one fastening plate.

5. The furniture according to claim 1, wherein the at least one fastening protrusion comprises at least one hole.

6. The furniture according to claim 1, wherein the at least one fastening protrusion comprises a plurality of holes.

7. The furniture according to claim 3, wherein the at least one fastening protrusion comprises a plurality of protrusions.

8. The furniture according to claim 7, wherein the plurality of protrusions are connected to the plurality of plates.

9. The furniture according to claim 1, wherein the at least one fastening piece is attached to a first end of the least one second piece.

10. The furniture according to claim 9, wherein the at least one fastening piece comprises a plurality of fastening pieces and the plurality of fastening pieces are attached to the first end and a second end of the least one second piece.

11. The furniture according to claim 9, wherein the at least one fastening piece comprises at least one groove.

12. The furniture according to claim 9, wherein the at least one fastening piece comprises a plurality of grooves.

13. The furniture according to claim 4, wherein the at least one fastening piece comprises at least one groove and the at least one fastening protrusion is inserted into the at least one groove.

14. The furniture according to claim 8, wherein the at least one fastening piece comprises a plurality of fastening pieces and the plurality of fastening pieces comprises a plurality of grooves and each of the plurality of protrusions are inserted into each of the plurality of grooves.

15. The furniture according to claim 1, the furniture further comprises at least one aperture in at least one of the plurality of pieces.

16. The furniture according to claim 1, the furniture further comprises a helical screw attaching two pieces of the plurality of pieces together.

17. The furniture according to claim 1, wherein each of the plurality of pieces is made from metal or wood.

18. The furniture according to claim 16, wherein one of the two pieces of the plurality of pieces has a plurality of apertures.

19. The furniture according to claim 18, wherein the plurality of apertures is circular in shape.

20. The furniture according to claim 1, each of the plurality of pieces is made from metal.
